(19) United States
(12) Patent Application Publication
(10) Pub. No.: US 2026/0109087 A1
(43) Pub. Date: Apr. 23, 2026

(54) METHOD FOR ADJUSTING THE TEMPERATURE INSIDE A ROTATIONAL MOLDING CHAMBER

(71) Applicant: POLIVINIL ROTOMACHINERY S.P.A., Cerano (Novara) (IT)

(72) Inventor: Pierluigi SACCHI, Vigevano (Pavia) (IT)

(73) Assignee: POLIVINIL ROTOMACHINERY S.P.A., Cerano (Novara) (IT)

(21) Appl. No.: 19/120,510

(22) PCT Filed: Oct. 17, 2023
(86) PCT No.: PCT/EP2023/078804

§ 371 Date: Apr. 11, 2025

(30) Foreign Application Priority Data
Oct. 18, 2022 (IT) 102022000021429

(51) Int. Cl. B29C 41/46; B29C 41/06; B29C 41/52

(52) U.S. Cl. CPC B29C 41/46; B29C 41/06; B29C 41/52

(57) ABSTRACT

The present invention relates to a method for adjusting the temperature inside a rotational molding chamber, wherein plastic material present inside a mold is heated to cause the melting thereof and the subsequent molding into the desired shape. In particular, the invention relates to a method for adjusting the temperature to optimal values inside a rotational molding chamber, irrespective of the different configuration and arrangement of the stations responsible for carrying out the molding steps, using a hybrid heating system of the air conveyed inside the rotational molding chamber.

### TECHNICAL FIELD

The present invention relates to a method for adjusting the temperature inside a rotational molding chamber, wherein plastic material present inside a mold is heated to cause the melting thereof and the subsequent molding into the desired shape.

In particular, the invention relates to a method for adjusting the temperature to optimal values inside a rotational molding chamber, using a hybrid heating system of the air conveyed inside the rotational molding chamber.

### BACKGROUND ART

It is well known that rotational molding, or rotomolding, is a low-pressure, high-temperature production method for the manufacture of hollow articles, which do not require subsequent welding and assembly steps and are virtually stress-free. The process can be used to make bodies of simple shapes (cylindrical containers or tanks) or more complex ones (furnishings or automotive components) with wall thicknesses ranging from 2 to 15 millimetres. In this type of application, the technology is a viable alternative to blowing, thermoforming and injection molding, and allows for the cost-effective production of small and medium series (approx. 8,000/10,000 pieces per year per single mold), even with very large sizes. The modern machines provided with multiple arms, which allow the simultaneous installation of molds of different shapes and sizes, enable the simultaneous production of different articles and thus optimize productivity.

Rotational molding typically originates for the production of containers, exploiting the possibility of quickly obtaining hollow products without subsequent welding and assembly steps. The applications have also multiplied thanks to the continuous evolution of research applied to the polymers used in the process: these include mainly polyethylene, polypropylene, ethylene vinyl acetate (EVA), nylon, polycarbonate and PVC.

The rotational molding process consists of introducing the plastic material (in liquid or powder form) into the mold, which is rotated simultaneously on two perpendicular axes so that the polymer can reach every point on the inner surface of the mold. The formation of the article occurs differently depending on whether the plastic material used is powder or liquid. During the heating step, the powder initially forms a porous film on the inner surface of the mold, to which the rest of the material which gradually becomes fluid adheres. This results in the formation of a uniform layer that will solidify in the subsequent cooling step.

Instead, the liquid material (usually PVC and PLATISOL) flows along the walls of the mold and heats up until it reaches the temperature at which the fluid solidifies, assuming the shape of the mold, which is then cooled in a water bath or with blown air.

The most common rotational molding system uses a horizontal rotating unit, commonly called a carousel, provided with 3-4 or more mold-holding arms that are automatically passed through the different workstations (loading, firing, cooling, article extraction).

The cycle is fully automated and only the loading/unloading operations are manual: this is necessary so as to ensure the great versatility of the rotational molding process.

Furthermore, an important advantage of rotomolding is the fact that this technology generates relatively little waste, since a quantity of material corresponding to the weight of the finished part is fed into the mold.

Rotational molding is carried out at atmospheric pressure: a fundamental prerequisite is that the plastic material is capable of withstanding high temperatures for a relatively long time. Since no pressure is applied during the polymer forming, rotational molds generally have thin walls and are therefore relatively inexpensive to manufacture because, unlike injection molding, they do not require expensive metal alloys.

In rotational molding technology, several methods can be combined to perform mold heating and rotation. The most common technique involves a mold-holding device rotating on two axes, which is inserted into a hot-air blowing chamber, which hits the rotating mold, bringing it to the desired temperature and maintaining it at the required temperature for a desired period of time. Generally, the air in the rotating mold is heated by means of combustion of hydrocarbons, mainly methane, propane, butane, LPG and diesel.

In another recently applied system, the mold can be heated by means of electrical resistances that are in direct contact with the mold containing the plastic material to be molded. Such an electric mold heating system is shown, for example, in patent application WO2013/164765, which describes how each mold can be associated with its own temperature control device and that direct mold heating can be provided by electrical heaters placed in or on the wall of the mold itself. Alternatively, direct mold heating can be achieved by means of induction heating or infrared heating on the mold wall due to the presence of channels in the mold wall for the passage of a liquid or vapour at the desired temperature. According to what is described by WO 2013/164765, the temperature control device can be positioned integrally with the mold or be provided by the robotic arm on which the mold is mounted. However, this heating method has an increase in costs with regard to the adaptation of molds to the technology described above: in fact, the molds currently used must be modified accordingly, and in many cases the construction of new molds is required.

In another method, the molds are heated by passing hot oil through channels arranged in the mold wall: Mexican patent MX2014010226 describes a rotational molding technology in which molds can be heated by means of hot oil. All the cost disadvantages mentioned above with regard to heating elements placed in the mold channels can also be mentioned for molds heated by means of circulating hot oil.

The most common method currently used to achieve mold heating is to set up a combustion chamber in a position adjacent to the rotomolding chamber. A burner is present in the centre of the combustion chamber and is generally fed by natural gas as fuel. The air around the burner is heated to optimum values and conveyed by means of one or more fans into the nearby rotational molding chamber. Thereby, a forced circulation of hot air is created, which hits the mold, heats it, and is then sucked into the combustion chamber to be heated again.

This is not a very efficient energy transfer system, as it is characterized by high heat loss: in fact, the heating in this case is not selective and limited to the mold, but the entire molding chamber is invaded by hot air and subjected to heating, just as the support structure for the mold rotation undergoes undesired, unnecessary heating.

The main drawback of this mold heating method is the fact that large quantities of natural gas must be burnt in the burner in order to heat the entire air mass in the molding chamber to temperatures above 200° C.

As is well known, in recent months all fossil-derived combustible gases have undergone a considerable increase in their price per m³: this occurred abruptly, posing serious supply problems for many European countries, including Italy, also due to contingent events such as the war in Ukraine.

As a result, the above-described system of heating the rotomolding chamber, based on forced circulation of air heated by natural gas combustion, has become too costly for the industry.

There is therefore a strong need for a simple and innovative method for heating the mold in a rotational molding chamber, a method capable of significantly reducing the total quantity of gas required to maintain the mold at the desired temperature.

A first object of the present invention is to create a method for adjusting the temperature in a rotational molding chamber, overcoming all the above-mentioned drawbacks of mold heating systems adopted in conventional technology.

A second object of the present invention is to provide the industry with a hybrid heating method of the rotational molding chamber, such that the total emission of pollutants and CO2 released into the atmosphere is considerably reduced, by making use of at least partly renewable heating sources.

The Applicant has devised, tested and embodied the present invention to overcome the above-mentioned shortcomings of the state of the art and to obtain these and other objects and advantages.

### DISCLOSURE OF THE INVENTION

The present invention is expressed and characterized in the independent claims, while the dependent claims set forth other preferred and non-essential features of the present invention, or variants of the main solution idea.

A first object of the present invention relates to a method for adjusting the temperature inside a rotational molding chamber containing a mold heated by a flow of hot air coming from an adjacent combustion chamber, the method being characterized in that the temperature of the air inside said molding chamber is adjusted in a range between 200° C. and 300° C. by the combined operation of a fuel burner and one or more batteries of electrical resistances.

The adjustment method in accordance with the present invention involves the installation in or near the combustion chamber of one or more batteries of electrical resistances, appropriately managed by the control system to maintain the desired molding temperature. These batteries of electrical resistances can operate either as an exclusive mold heating system or as a heating system operating simultaneously with the fuel burner.

The operation of the fuel burner and/or electrical resistances is managed by the control system of the machine to maintain the desired molding temperature. As mentioned, the temperature of the air inside the molding chamber is set at values between 200° C. and 300° C., preferably between 240° C. and 280° C., depending on the plastic material to be molded.

The integrated, hybrid heating from the fuel burner and batteries of electrical resistances ensures that the above-mentioned temperature values are maintained throughout the entire molding process, most effectively minimizing fuel consumption sent to the burner.

The fuel feeding the burner can be chosen from the main hydrocarbons, such as natural gas/methane, LPG and diesel.

According to a first embodiment of the invention, the fuel burner and the batteries of electrical resistances are both placed inside the combustion chamber.

In accordance with a second embodiment of the invention, the fuel burner is placed inside the combustion chamber, while one or more batteries of electrical resistances are placed along the duct to recycle the hot air that is reintroduced into the combustion chamber.

The adjustment method according to the invention involves the use of a temperature control (TC) device, which detects the air temperature in the molding chamber at all times during the molding of the plastic material.

Based on the temperature value detected in the molding chamber, the temperature control (TC) device is capable of acting on the combined operation of the two heating systems, i.e., acting on both the fuel burner and the battery of electrical resistances so as to optimize the degree of heating of the air in direct contact with the mold.

In particular, the device (TC) can vary the flow rate of fuel fed into the burner and, simultaneously, can switch the individual sections that make up the batteries of the electrical resistances on or off.

The device (TC) receives the value detected inside the molding chamber in real time from the probe(s). In the initial molding step, the mold is not yet present in the molding chamber and the internal temperature is that of the environment. The management system of the machine, by means of the device (TC), therefore starts the burner, which brings the temperature to the set point required by the production recipe, depending on the type of plastic material to be molded.

Once the desired temperature has been reached, the molding step begins, during which the raw material, as well as the supporting structure of the mold and the combustion chamber itself, heat up, thus removing heat. The temperature would therefore tend to drop, but its optimum value is restored thanks to the intervention of the batteries of electrical resistances that heat the air that hits them, air that is again directed onto the mold by means of a system of fans present between the combustion chamber and the molding chamber.

The temperature control (TC) device gradually switches the batteries of electrical resistances on in sections, increasing the heated exchange surface area so as to ensure the set temperature level. In this step of the process regime, the device (TC) keeps the burner off or idling and ensures the optimum temperature by switching the various sections of the batteries of electrical resistances on or off. Only if the temperature drops above the preset limits, the device (TC) triggers the gas burner to quickly restore the desired temperature level.

In accordance with the method of the present invention, the combined operation of the two heating systems allows the burner to be used essentially to quickly reach the desired temperature and the battery of electrical resistances to maintain the desired temperature inside the molding chamber.

### DETAILED DESCRIPTION OF THE INVENTION

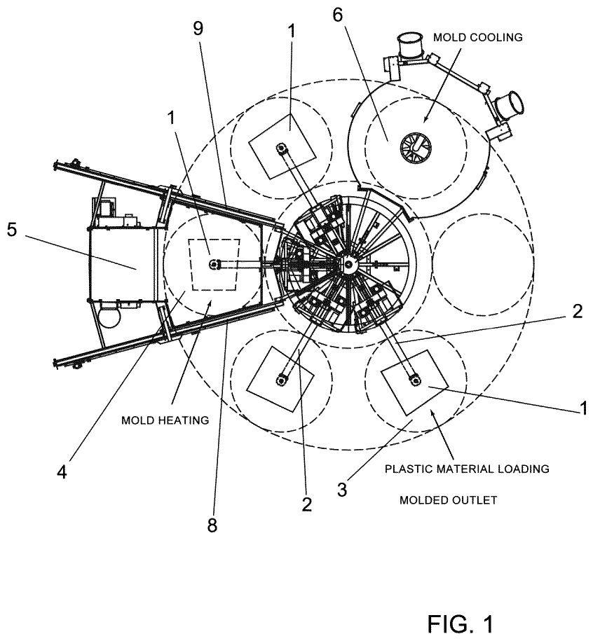

The method for adjusting the temperature in a rotational molding chamber according to the present invention will now be described in detail with reference to the attached FIGS. 1 to 3, which are to be considered merely as examples and not limiting the scope of the present invention.

FIG. 1 shows a simplified diagram of the rotational molding process, highlighting its different work steps: mold loading, mold heating, mold cooling and piece extraction.

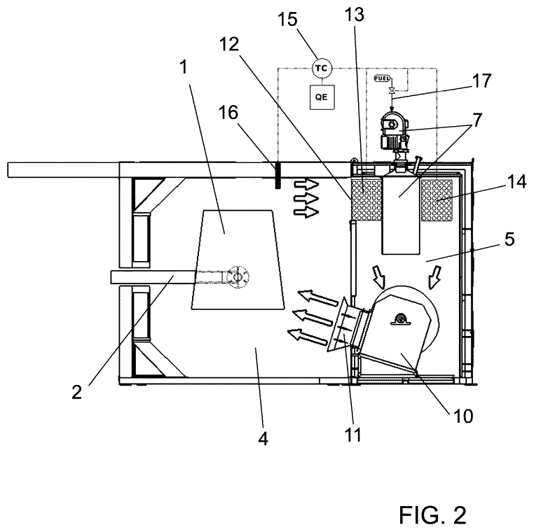

FIG. 2 shows a plant schematic in which a first embodiment of the adjustment method of the invention is arranged, in which the electrical resistances are placed inside the combustion chamber.

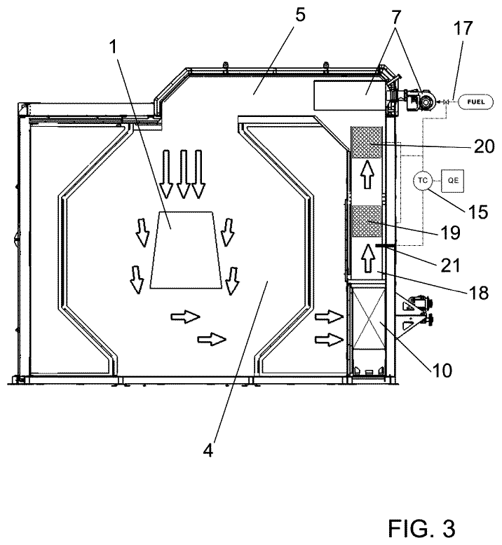

FIG. 3 shows a plant schematic in which a second embodiment of the adjustment method of the invention is arranged, in which the electrical resistances are placed along the recycle duct of the hot air reintroduced into the combustion chamber.

FIG. 1 shows a simplified schematic of a rotational molding process, highlighting the various working zones and the relative steps in the case of a “carousel” configuration, where the zones are arranged around a circumference with the centre corresponding to the centre of the plant. Also common are “in-line” configurations where the material loading, cooling and article extraction steps are carried out in the same position.

The present invention is also directly applicable to other and different configurations of workstations, known in the industry as shuttle, tilting furnace, etc., characterized by different positioning and organisation of the work steps. In particular, rotational molding technology involves four steps: mold loading, mold heating, mold cooling and molded piece extraction.

FIG. 1 shows a mold 1, generally consisting of metal alloys, which is secured either individually or with other molds to a rotation arm 2, which causes the mold to rotate around two axes, placed perpendicular to each other. Thanks to appropriate handling systems (“carousel”, around an axis at the centre of a structure, or “in line” on rails) the arm/mold assembly moves through the four above-mentioned molding steps.

The first workstation, indicated with reference 3, is where the loading of the plastic material inside the mold 1 occurs. During this step, the mold 1 is loaded at room temperature with a predefined quantity of plastic powder, equivalent to the weight of the desired product. The quantity loaded is determined based on the surface area of the mold 1, the expected wall thickness of the final component and the density of the polymer used.

Once the plastic material is loaded, the mold 1 is closed, so as to prevent the material from exiting, and the rotation arm 2 moves it at the rotational molding chamber 4, where it is simultaneously rotated around the horizontal and vertical axis of the arm 2 to which it is secured, at different speeds for each axis, as a function of the shape to be obtained, however generally less than 20 rpm, so as to ensure that the material reaches every point of the inner surface of the mold and is deposited in the desired quantity.

In accordance with the adjustment method of the present invention, the mold 1 inside the rotational molding chamber 4 is heated by a flow of hot air coming from an adjacent combustion chamber 5. Furthermore, the temperature of the air inside the molding chamber 4 is adjusted in a range between 200° C. and 300° C. by means of the combined operation of a fuel burner and one or more batteries of electrical resistances, the operation of which will be explained in detail in FIGS. 2-3 below.

At the beginning of the heating step, the polymer is at the bottom of the mold 1, but when the biaxial rotation is started, the entire surface of the mold 1 heated by the hot air coming from the combustion chamber 5, comes into contact with the powder and becomes coated with molten plastic. By changing the speed of the two rotation axes, which are perpendicular to each other, it is possible to adjust the thickness of the mold walls: areas where a greater thickness is desired will have to come into contact with the powder more often with respect to the other parts of the surface of the mold 1. The ratio between the rotation speeds around the two axes can be set to different values based on the geometry of the article to be made.

When the temperature of the inner surface of mold 1 is sufficiently high, the plastic material begins to adhere thereto. With the rotation, the raw material flows inside mold 1 and takes the shape thereof until the polymer is entirely deposited over its entire inner surface.

Once the molding step is complete, the rotation arm 2 moves the mold 1 to the workstation 6, where the mold 1 undergoes the cooling step to room temperature. The mould 1 continues to rotate also in this step, during which it is usually exposed to high-speed jets of air and, in some cases, water spray in order to cool it down gradually. It should be kept in mind that if the cooling is carried out too quickly, the article could deform. As the plastic material cools, it passes from a viscous liquid state to a semi-solid state, eventually transforming into a solid article. Once sufficiently cooled, the rotation arm 2 moves the mold until reaching the workstation 3 again, where the mold 1 can be opened so as to extract the molded plastic article (molded outlet). At this point, new powdered plastic material can be loaded in the mold 1 and the cycle repeated continuously.

FIG. 2 illustrates a first embodiment of the adjustment method of the invention, in which the batteries of electrical resistances are placed inside the combustion chamber 5 near the fuel burner.

The mold 1 is carried by the rotation arm 2 inside the rotational molding chamber 4 to undergo heating to high temperatures, so as to cause the plastic material contained therein to melt. The combustion chamber 5 is positioned adjacent to the molding chamber 4 and contains a fuel burner 7 in its upper part. The fuel used is preferably gaseous, in particular natural gas can be used.

The rotational molding chamber 4 is provided with sliding doors on special guides, indicated with references 8 and 9 in FIG. 1, which serve respectively for the entry of the mold 1 in the molding chamber 4 and for its exit from the chamber 4 once the molding of the plastic material has been completed. The opening of these sliding doors 8 and 9 causes severe heat loss, a drop in temperature and the need for it to be restored to the desired level.

The mould 1 is heated by convection, in particular hot air is produced in the combustion chamber 5 by means of the fuel burner 7. The hot air is forced to enter a fan 10 located in the underlying part of the combustion chamber 5: the fan 10 conveys the hot air through the diffuser 11 in the lower part of the molding chamber 4 (see the directional arrows exiting the diffuser 11). High-temperature air hits the mold 1 in rotation, causing the plastic material to be molded to melt.

The forced circulation of hot air hits the mold 1 from below upwards, and then this hot air is reintroduced into the upper part of the combustion chamber 7 by means of the opening 12 between the molding chamber 4 and the combustion chamber 5. Downstream of the opening 12, there are two batteries 13 and 14 of electrical resistances, respectively on the right and left side of the burner 7. Therefore, in accordance with the teachings of the present invention, the temperature adjustment of the air flow to be sent into the molding chamber 4 is achieved by the combined operation of the burner 7 and the batteries 13, 14 of electrical resistances.

The batteries of electrical resistances 13, 14 operate either as an exclusive air heating system or as an aid to the burner 9.

During the molding of the plastic material, a temperature control (TC) device 15 detects the air temperature in the molding chamber 4 at all times by means of the temperature sensor 16. Based on this temperature value, the device 15 can simultaneously act on both the operating level of the burner 7 and the operating level of batteries 13, 14 of electrical resistances.

In particular, the temperature control device 15 can adjust the flow rate of fuel that is fed in the burner 7 by means of the supply line 17 and, simultaneously, it can switch the individual sections forming the batteries 13, 14 of electrical resistances on or off.

FIG. 3 shows an alternative embodiment of the invention to that of FIG. 2, in which the electrical resistances are placed along the recycle duct of the hot air fed reintroduced in the combustion chamber.

As in the previous case illustrated in FIG. 2, the mold 1 is positioned inside the rotational molding chamber 4, while the combustion chamber 5 is in the form of a duct with a horizontal axis, the left portion of which is in direct contact with the molding chamber 4, while its right portion contains the burner 7.

The hot air is produced by means of the burner 7 in the combustion chamber 5. High-temperature air from the burner 7 enters the molding chamber 4 and hits the mold 1 in rotation with a direct flow mainly from the top downwards.

A recycle duct 18 of the hot air connects the bottom portion of the molding chamber 4 with the combustion chamber 5. The flow of hot air is forced to enter the recycle duct 18 by the presence of the fan 10 positioned in the lower part of the recycle duct 18. Two batteries 19 and 20 of electrical resistances are placed in sequence along the hot air recycle duct 18: they have the task of contributing to the adjustment of the temperature of the air before it is reintroduced into the molding chamber 4. The adjustment of the temperature of the air flow to be sent into the molding chamber 4 is therefore achieved by means of the combined operation of the burner 7 and the batteries 19, 20 of electrical resistances positioned along the recycle duct 19.

During the molding of the plastic material, a temperature control (TC) device 15 detects at all times the temperature of the air which is sent into the molding chamber 4 by means of a temperature sensor 21, which in the case of FIG. 3 is located in the recycle duct 18. Based on this temperature value, the device 15 can adjust both the flow rate of the fuel that is fed into the burner 7 by means of the supply line 17 and, simultaneously, it can switch the individual sections forming the batteries 19, 20 of electrical resistances on or off.

The following guidelines can be defined with regard to the integrated operation of burner 7 and the batteries 13,14,19,20 of electrical resistances:
A) The burner operates along only in the event of a cold molding chamber at the start of a molding shift, or in the event of a temperature drop due to a changeover of new cold molds, which implies the opening of the rotational molding chamber with the consequent entry of air at room temperature;
B) The electrical resistances operate alone for most of the firing step of the mold, being suitably dimensioned to manage slight temperature fluctuations within the preset range;
C) The burner and electrical resistances operate simultaneously in integrated mode at the beginning of the molding cycle, when the burner brings the temperature to the set level (temperature set point) it adjusts the fuel flow rate until it switches off, while the resistances start the heat supply in order to maintain the temperature set point. During the molding cycle, should the temperature fall below the set point, due to special mold or process conditions, the burner will switch on again for the time required to bring the temperature back to the desired set point, after which it will switch off and the active resistances will continue to maintain the temperature (as illustrated above).

The method for adjusting temperature described with reference to the attached FIGS. 1-3 is simple to implement and has the advantage of significantly reducing the total amount of gas required to maintain the mold at the desired temperature (200-300° C.): this translates into significant savings in plant energy costs.

Furthermore, the claimed adjustment method has the further advantage of reducing the total emission of pollutants and CO2 released into the atmosphere, as the batteries of electrical resistances can advantageously be powered by renewable energy sources, e.g., photovoltaic systems, wind power plants.

The present invention is not limited to the particular embodiments previously described in relation to FIGS. 1-3, but numerous modifications can be made to it in detail, within the reach of the person skilled in the art, without thereby departing from the scope of the invention itself, as defined in the appended claims.

1. Method for adjusting the temperature inside a rotational molding chamber containing a mold heated by a flow of hot air coming from an adjacent combustion chamber, wherein:
the air temperature inside said molding chamber is adjusted in a range between 200° C. and 300° C. by the combined operation of a fuel burner and one or more batteries of electrical resistances.

2. Method according to claim 1, wherein said fuel burner and said batteries of electrical resistances are both located inside said combustion chamber.

3. Method according to claim 1, wherein said batteries of electrical resistances are placed along the recycle duct of the hot air entering said combustion chamber.

4. Method according claim 1, wherein said air temperature in the molding chamber is adjusted in a range between 240° C. and 280° C.

5. Method according to claim 1, wherein it involves the use of a temperature control device, which, based on the temperature value detected in the molding chamber, acts on the combined degree of operation of said fuel burner and said batteries of electrical resistances.

6. Method according to claim 5, wherein said temperature control device acts on the flow rate of fuel fed into said burner and, simultaneously, turns on or off the individual sections of said batteries of electric resistances.

7. Method according to claim 1, wherein at the beginning of the molding step, said fuel burner is activated by said temperature control device to bring the temperature of the air in said molding chamber up to the set point value requested by the production recipe, based on the plastic material to be molded.

8. Method according to claim 7, wherein once said set point temperature has been reached, said device maintains this temperature value unchanged during the molding by turning on or off the individual sections of said batteries of electrical resistances.
